(19) United States
(12) Patent Application Publication
(10) Pub. No.: US 2026/0208302 A1
(43) Pub. Date: Jul. 23, 2026

(54) PROTECTIVE MULTIWINDOW CARTRIDGE ASSEMBLY

(71) Applicant: IPG PHOTONICS CORPORATION, Marlborough, MA (US)

(72) Inventors: Nam LY, Dudley, MA (US); Yuri GRAPOV, Sutton, MA (US); Nikhit NAIR, Hudson, MA (US)

(73) Assignee: IPG PHOTONICS CORPORATION, Marlborough, MA (US)

(21) Appl. No.: 19/143,156

(22) PCT Filed: Dec. 11, 2023
(86) PCT No.: PCT/US2023/083326

§ 371 Date: Jun. 25, 2025

Related U.S. Application Data
(60) Provisional application No. 63/435,623, filed on Dec. 28, 2022.

(51) Int. Cl. B23K 26/70

(52) U.S. Cl. CPC B23K 26/706; B23K 26/707

(57) ABSTRACT

A method and device that include a multiwindow cartridge assembly that can be used for protecting optical assemblies in a laser head. The multiwindow cartridge assembly includes a window mount configured to support and rotate a transparent window about a rotation axis, an aperture configured for permitting passage of a processing laser beam along an optical axis, the optical axis passing through a processing position on the transparent window, a housing for enclosing at least a portion of the transparent window and the window mount and configured to form at least a portion of the aperture, and a rotation mechanism configured to engage with at least a portion of the window mount for rotating the transparent window about the rotation axis to rotational positions, the rotational positions including the processing position.

### BACKGROUND

### Technical Field

The technical field relates generally to a protective window assembly, and more specifically to a protective window assembly for use in combination with a laser processing head.

### Background Discussion

Contamination is a frequent problem on interior surfaces of laser windows used in laser material processing heads. Contamination takes the form of particulates that accumulate on the surfaces of the windows and interfere with laser beam transmission. Contamination typically occurs during installation and gradually accumulates on laser optics. Emitted radiation from the processing laser burns the contaminants and destroys the optics within the head, which requires the optics to be removed and replaced. The protective windows have to be removed and replaced at fairly frequent intervals and by some estimates create as much as 90% of the downtime experienced during material processing operations. In addition, the act of removing and replacing the windows also exposes the laser optics to contaminants.

### SUMMARY

Aspects and embodiments are directed to a multiwindow cartridge assembly and to its use.

In accordance with an exemplary embodiment, there is provided a multiwindow cartridge assembly that includes a window mount configured to support and rotate a transparent window about a rotation axis, an aperture configured for permitting passage of a processing laser beam along an optical axis, the optical axis passing through a processing position on the transparent window, a housing for enclosing at least a portion of the transparent window and the window mount and configured to form at least a portion of the aperture, and a rotation mechanism configured to engage with at least a portion of the window mount for rotating the transparent window about the rotation axis to rotational positions, the rotational positions including the processing position.

In one example, the window mount is further configured to support the transparent window at an angle.

In one example, the multiwindow cartridge assembly further includes a position indicator configured to indicate the rotational position of the transparent window.

In one example, the optical axis is parallel to the rotation axis.

In one example, the multiwindow cartridge further includes a frame assembly configured to hold the transparent window in the housing.

In one example, the window mount is a first window mount and the assembly further includes a second window mount configured to support and rotate a second transparent window.

In one example, the transparent window is coupled to at least a portion of an optic assembly that optically interacts with the processing laser beam. In a further example, the optic assembly is configured to focus the processing laser beam. In a further example, the optic assembly is configured to collimate the processing laser beam.

In one example, the window mount is configured to support more than one transparent window.

In accordance with another exemplary embodiment, there is provided a laser system for performing a material modification process on a workpiece that includes a laser source configured to generate a processing laser beam, and a laser head, the laser head configured to receive the processing laser beam from the laser source and including: focusing optics configured to focus the processing laser beam, a multiwindow cartridge assembly disposed downstream of the focusing optics, the multiwindow cartridge assembly including: a window mount configured to support and rotate a transparent window about a rotation axis, an aperture configured for permitting passage of the processing laser beam along an optical axis, the optical axis passing through a processing position on the transparent window, a housing for enclosing at least a portion of the transparent window and the window mount and configured to form at least a portion of the aperture, and a rotation mechanism configured to engage with at least a portion of the window mount for rotating the transparent window about the rotation axis to rotational positions, the rotational positions including the processing position.

In one example, the laser head further includes a contamination sensor configured to detect contamination on at least one planar surface of the transparent window. In a further example, the contamination sensor is configured as a visible light photodiode. In a further example, the laser system further includes a controller coupled to the contamination sensor that is configured to: receive a contamination measurement from the contamination sensor, compare the contamination measurement to a predetermined contamination threshold value; and responsive to the comparison, send a notification to a display device. In one example, the controller is configured to send the notification when the contamination measurement exceeds the predetermined contamination threshold value. In another example, the laser head further includes a temperature sensor and the controller is configured to: receive a temperature measurement from the temperature sensor, compare the temperature measurement to a predetermined temperature threshold value, and responsive to the comparison, perform at least one of: send a notification to the display device, and control the laser source. In one example, the controller is configured to send the notification and/or control the laser source when the temperature measurement exceeds the predetermined temperature threshold value.

In one example, the multiwindow cartridge assembly is a first multiwindow cartridge assembly and the laser head further includes: a collimator configured to collimate the processing laser beam, the collimator positioned upstream from the focusing optics, and a second multiwindow cartridge assembly disposed upstream of the collimator.

In one example, the window mount of the multiwindow cartridge assembly is configured to support the transparent window at an angle.

In one example, the multiwindow cartridge assembly further includes a position indicator configured to indicate the rotational position of the transparent window. In a further example, the laser head further includes a housing configured with an opening that exposes at least a portion of the rotation mechanism and the position indicator. In one example, the laser head further includes a cover door configured to attach to the housing and cover the opening.

In one example, the laser head further includes a housing configured to seal the multiwindow cartridge within an interior of the housing.

In one example, the laser source is configured as a fiber laser and the processing laser beam is supplied to the laser head by an optical fiber.

In accordance with another exemplary embodiment, there is provided a method of protecting an optics assembly included in a laser processing head that includes providing a multiwindow cartridge assembly that houses a transparent window, the transparent window configured to protect the optics assembly, exposing a first rotational processing position on the transparent window to an environment containing contaminants, measuring an intensity of scattered radiation from a planar surface of the transparent window, comparing the measured intensity to a predetermined contamination threshold, and responsive to the comparison, providing a notification when the measured intensity exceeds the predetermined contamination threshold.

In one example, the method further includes rotating the transparent window to a second rotational processing position when the measured intensity exceeds the predetermined contamination threshold. In a further example, the transparent window is provided with N rotational processing positions and the method further includes the exposing, measuring, comparing, and rotating until each of the N rotational processing positions have been exposed.

In one example, the optics assembly is configured to focus a processing laser beam that is passed through the laser head and the first rotational processing position.

In one example, the optics assembly is configured to collimate a processing laser beam that is passed through the laser head and the first rotational processing position.

In one example, the method further includes measuring a temperature in a vicinity of the transparent window, comparing the measured temperature to a predetermined temperature threshold, and responsive to the comparison, performing at least one of providing a notification and controlling a laser source that generates a processing laser beam that is passed through the laser head when the measured temperature exceeds the predetermined temperature threshold. In a further example, the method further includes rotating the transparent window to a second rotational processing position when the measured temperature exceeds the predetermined temperature threshold.

In one example, the method further includes providing the laser processing head.

In accordance with another exemplary embodiment, there is provided a laser processing head that includes focusing optics configured to focus a processing laser beam, a multiwindow cartridge assembly disposed downstream of the focusing optics, the multiwindow cartridge assembly including: a window mount configured to support and rotate a transparent window about a rotation axis, an aperture configured for permitting passage of the processing laser beam along an optical axis, the optical axis passing through a processing position on the transparent window, a housing for enclosing at least a portion of the transparent window and the window mount and configured to form at least a portion of the aperture, and a rotation mechanism configured to engage with at least a portion of the window mount for rotating the transparent window about the rotation axis to rotational positions, the rotational positions including the processing position.

In one example, the multiwindow cartridge assembly is a first multiwindow cartridge assembly and the laser processing head further includes a collimator configured to collimate the processing laser beam, the collimator positioned upstream from the focusing optics, and a second multiwindow cartridge assembly disposed upstream of the collimator.

In one example, the laser processing head further includes at least one of a contamination sensor configured to detect contamination on at least one planar surface of the transparent window and a temperature sensor configured to measure a temperature in a vicinity of the transparent window.

In one example, the window mount of the multiwindow cartridge assembly is configured to support the transparent window at an angle.

In one example, the multiwindow cartridge assembly further includes a position indicator configured to indicate the rotational position of the transparent window.

In one example, the laser processing head further includes a housing configured with an opening that exposes at least a portion of the rotation mechanism and the position indicator. In a further example, the laser processing head further includes a cover door configured to attach to the housing and cover the opening.

In one example, the laser processing head further includes a housing configured to seal the multiwindow cartridge within an interior of the housing.

In one example, the processing laser beam is generated by a fiber laser source supplied to the laser processing head by an optical fiber.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Embodiments disclosed herein may be combined with other embodiments, and references to “an embodiment,” “an example,” “some embodiments,” “some examples,” “an alternate embodiment,” “various embodiments,” “one embodiment,” “at least one embodiment,” “this and other embodiments,” “certain embodiments,” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a perspective view of a schematic representation of one example of a multiwindow cartridge assembly in accordance with aspects of the invention;

FIG. 1A is a first example of a cross-sectional view of the multiwindow cartridge assembly of FIG. 1 taken along line “A” in a perpendicular plane;

FIG. 1B is a top cross-sectional view of the multiwindow cartridge assembly of FIG. 1 taken along a horizontal plane through the center of the assembly;

FIG. 2 is a perspective view of one example of a transparent window indicating various rotational processing positions in accordance with aspects of the invention;

FIG. 3 is a second example of a cross-sectional view of the multiwindow cartridge assembly of FIG. 1 taken along line “A” in a perpendicular plane;

FIG. 4 is a cross-sectional view of a schematic representation of one example of a laser head configured with at least one multiwindow cartridge assembly in accordance with aspects of the invention;

FIG. 5 is a perspective view of a schematic representation of one example of a laser head configured with at least one multiwindow cartridge assembly in accordance with aspects of the invention; and

FIG. 6 is a simplified block diagram representation of a laser system in accordance with aspects of invention.

### DETAILED DESCRIPTION

Aspects and embodiments are directed to a multiwindow cartridge assembly and its use in combination with a laser processing head. The multiwindow cartridge assembly addresses problems mentioned above related to the frequent replacement of protective windows used in laser heads that function to protect optics such as focusing optics from contamination. For example, the disclosed multiwindow cartridge assembly is configured to rotate the protective window through multiple rotational positions, one of which is the processing position. This allows for the protective window to be rotated such that a “clean” location is in the processing position and for the window to be swapped out at less frequent intervals.

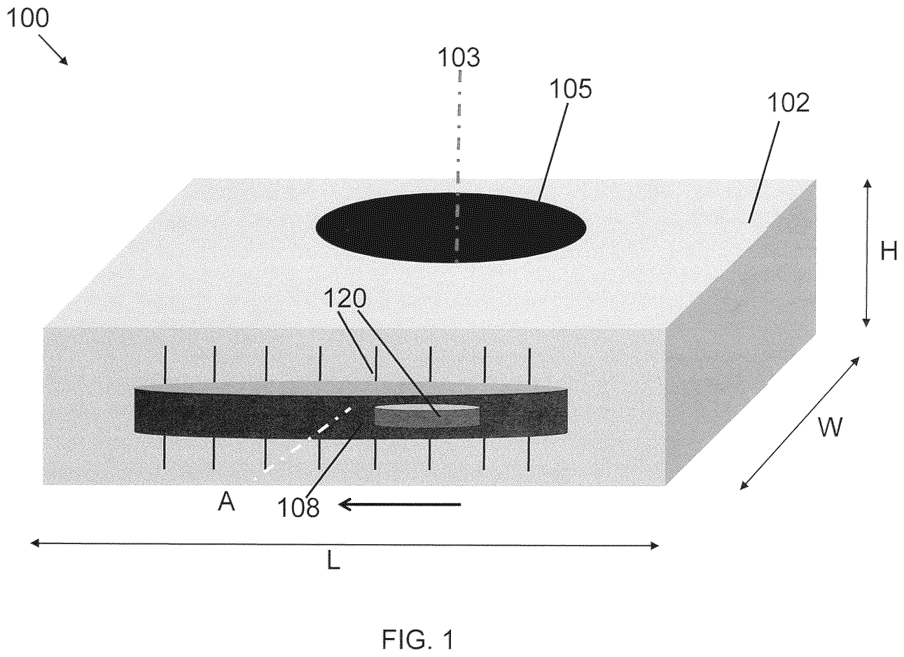

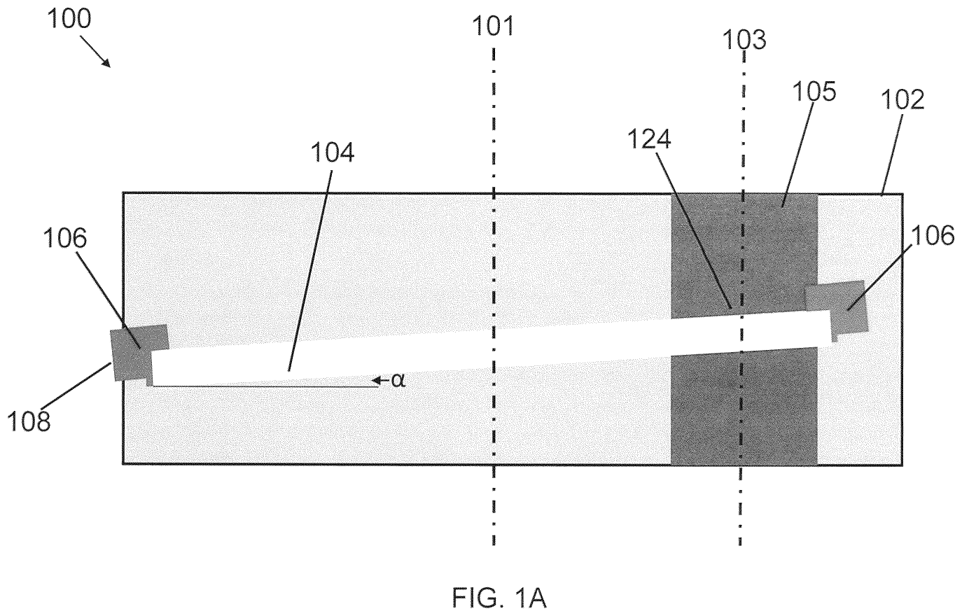

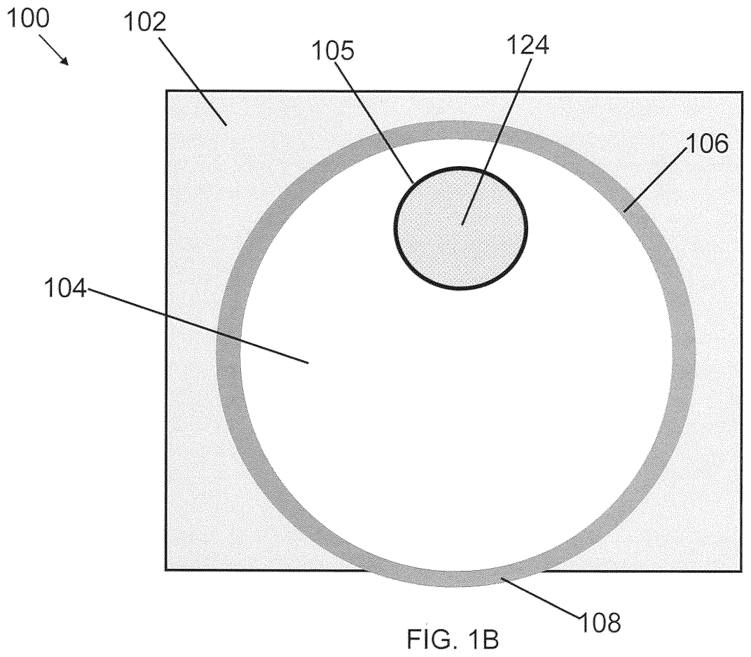

FIG. 1 is a schematic representation showing a perspective view of one non-limiting example of a multiwindow cartridge assembly 100 (also referred to herein as simply “cartridge assembly” or “assembly”) in accordance with at least one embodiment. The multiwindow cartridge assembly 100 comprises a window mount 106 (see FIGS. 1A and 1B), an aperture 105, a housing 102, and a rotation mechanism 108.

FIG. 1A is a cross-sectional view of the multiwindow cartridge assembly 100 of FIG. 1 taken along line “A” in a perpendicular plane, and FIG. 1B is a top cross-sectional view of the multiwindow cartridge assembly 100 of FIG. 1 taken along a horizontal plane through the center of the assembly. The window mount 106 (also referred to herein as a “bushing”) is configured to support and rotate the transparent window 104 about a rotation axis 101. In some embodiments, the window mount 106 attaches to at least one or more circumferential edges of the transparent window 104 and can be rotated 360 degrees around the rotational axis 101, which in turn allows the transparent window 104 to be rotated 360 degrees. The window mount 106 is also configured to maintain or otherwise support the transparent window 104 at an angle, as can be seen by angle a in FIG. 1A. Having the transparent window 104 at an angle prevents back-reflection so that processing light is not reflected directly back through the optics (e.g., fiber, collimating and/or focusing lenses, discussed in further detail below). In some embodiments, the window is mounted at an angle that is in a range from 0.5 to 10 degrees inclusive. In some embodiments, the transparent window 104 is not configured at an angle.

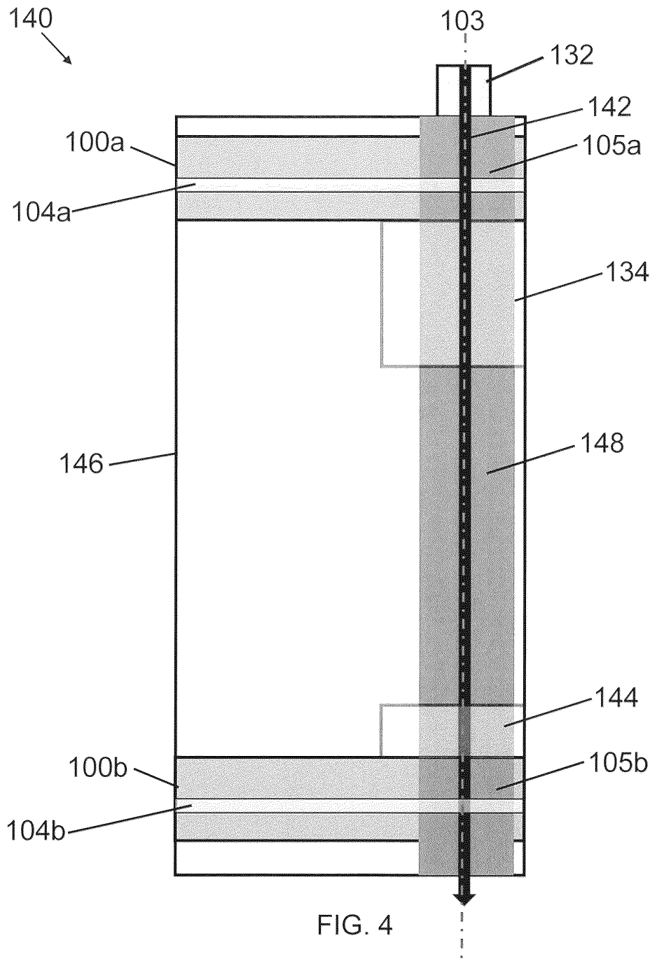

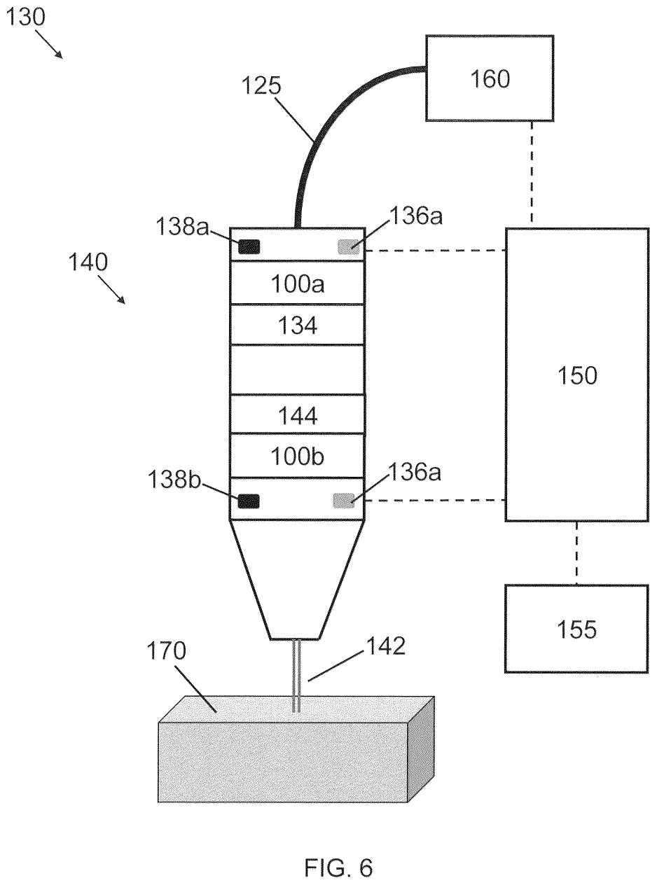

Aperture 105 is configured for permitting passage of a processing laser beam 142 (see FIGS. 4 and 6) along an optical axis 103. The aperture 105 extends through the full height (H) dimension of the multiwindow cartridge assembly 100. The processing laser beam 142 is generated by a laser source 160 (see FIG. 6) and passes through the aperture 105 along the optical axis 103. The optical axis 103 and the rotational axis 101 are parallel with one another. As used herein, the term “upstream” refers to the direction toward the laser source 160, and the term “downstream” refers to the direction toward the workpiece 170 where the processing laser beam 142 interacts with material of the workpiece 170. The transparent window 104 (also referred to herein as simply a “window”) extends into and across the aperture 105, as can be seen in FIG. 1A. This area of the transparent window 104 that extends across the aperture 105 and is exposed to the processing laser beam 142, sources of contamination, and/or other sources of heat is referred to as the processing position 124 (also referred to herein as one of the rotational processing positions), as can be seen in FIG. 1B. As will be appreciated, the optical axis 103 also passes through the processing position 124.

The housing 102 of the multiwindow cartridge assembly 100 encloses at least a portion of the transparent window 104 and the window mount 106 and is configured to form at least a portion of the aperture. The housing 102 functions in part to protect the unused portions of transparent window 104 (described in further detail below). The housing 102 may also add to the modular aspect of the multiwindow cartridge assembly 100. According to at least one embodiment, the housing 102 can be removed from a laser head (described in more detail below) and replaced with a new cartridge assembly, or in other instances, the housing 102 may be removed and a new transparent window 104 may be installed in the assembly 100.

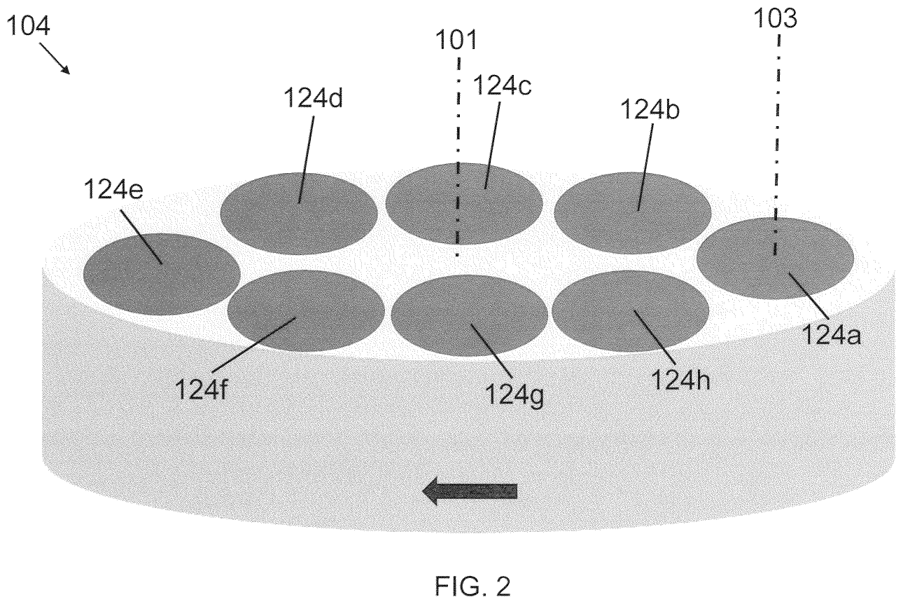

A rotation mechanism 108 of the multiwindow cartridge assembly 100 is configured to engage with at least a portion of the window mount 106 for rotating the transparent window 104 about the rotation axis 101. The rotation axis 101 passes through the approximate center of the transparent window 104. The rotation mechanism 108 rotates the transparent window 104 to rotational positions that include the processing position 124. This can be seen in the schematic representation of the transparent window 104 shown in FIG. 2, where rotational position 124a is the “current” processing position (and intersected by optical axis 103) and shown as 124 in FIGS. 1A and 1B. In this example, rotational position 124a represents the processing position that is exposed to contamination, and rotational positions 124b-124h are “clean” or “fresh” rotational positions protected by housing 102. Once the current processing position is contaminated to or beyond a certain threshold (discussed below), the window 104 is rotated to a new rotational processing position. In this example, the window 104 is rotated in the direction of the arrow in FIG. 2 such that rotational position 124b is moved into the aperture 105 and in line with optical axis 103 such that a “clean” surface of the transparent window 104 is now exposed to process radiation and contamination. This process repeats until all of the rotational positions are contaminated and a new window is needed. It to be appreciated that although the example in FIG. 2 indicates eight rotational positions, fewer (i.e., at least 2) or more rotational positions (e.g., 10) are within the scope of this disclosure. The number of positions is a function of one or more factors, including the size of the window 104 and the size of the aperture 105.

In accordance with at least one embodiment, the rotation mechanism 108 includes any component or components, such as support structure, that allows for the window mount 106 to rotate about the rotational axis 101. For example, in reference to FIG. 1, a user may rotate the transparent window 104 by engaging with 108 and pushing 108 in the direction of the shown arrow. In some embodiments, the window mount 106 is exposed so that a user may engage with and rotate the window 104.

According to at least one embodiment, multiwindow cartridge assembly 100 also includes a position indicator 120 that is configured to indicate the rotational position of the transparent window 104. This feature allows the user to know how many “clean” positions are left on the window, and in some embodiments, also provides an indication as to when the window 104 is fully rotated into a new “clean” position. The non-limiting example of the position indicator 120 shown in FIG. 1 includes a series of grooves or notches positioned on an exterior of the housing 102 that indicate the number of rotational positions 124, and provide a reference point for the pointer or indicator, which in this instance is formed on a sidewall of the window mount 106 and is intended to have an edge or marker that aligns with the notch or groove when a rotational position is fully engaged. It is to be appreciated that the position indicator may be any feature or set of features that conveys to the user the rotational position of the transparent window 104 and/or conveys to the user when a rotational position is engaged (i.e., rotated to a point where a completely clean surface is exposed in the aperture 105 and no portion of the previous rotational position that is currently contaminated or otherwise unusable/compromised is left exposed in the aperture 105).

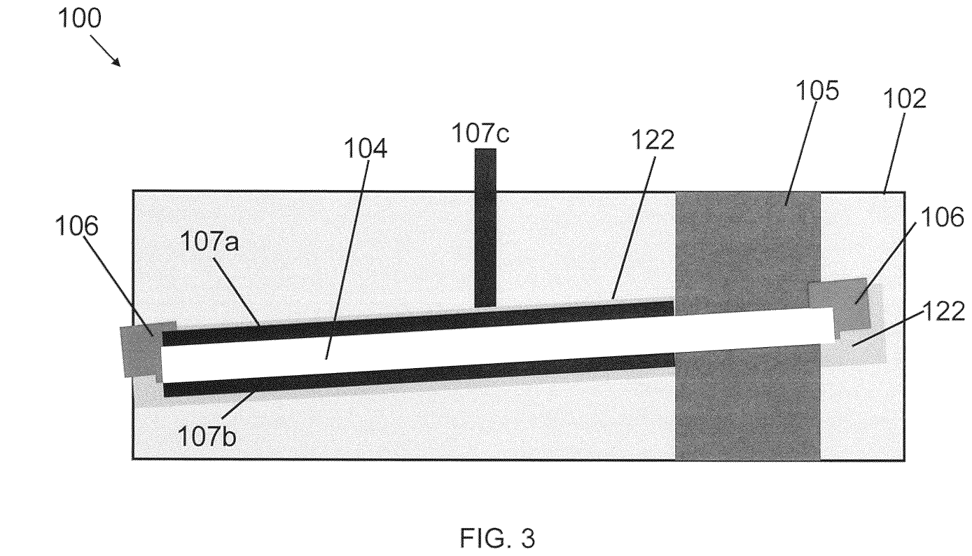

FIG. 3 is another example of a cross-sectional view of the multiwindow cartridge assembly 100 of FIG. 1 taken along line “A” in the perpendicular plane and shows one non-limiting example of a frame assembly 107 (shown as 107a, 107b, and 107c in FIG. 3). The frame assembly 107 is configured to hold the transparent window 104 in the housing 102. The frame assembly 107 comprises several components that provide kinematic restraint. For example, a top frame 107a and a bottom frame 107b hold the window through friction, and a screw 107c is used to apply force to the top and bottom frames 107a and 107b. The housing 102 is configured with a slot 122 for the top and bottom frames and the window mount 106 and force is transferred through the top frame 107a, the window mount 106, the transparent window 104, the bottom frame 107b, to the bottom of the slot 122. Other components (not shown in FIG. 3) may also be included, such as a ball and groove component, spring(s), O-ring(s), gasket(s), flange(s), etc. It is to be appreciated that the example frame assembly 107 shown in FIG. 3 is one non-limiting example and the frame assembly may comprise any one of a number of different component configurations that prevent the transparent window 104 from moving during laser processing operations and allow for the window to rotate without causing damage to the surface of the window.

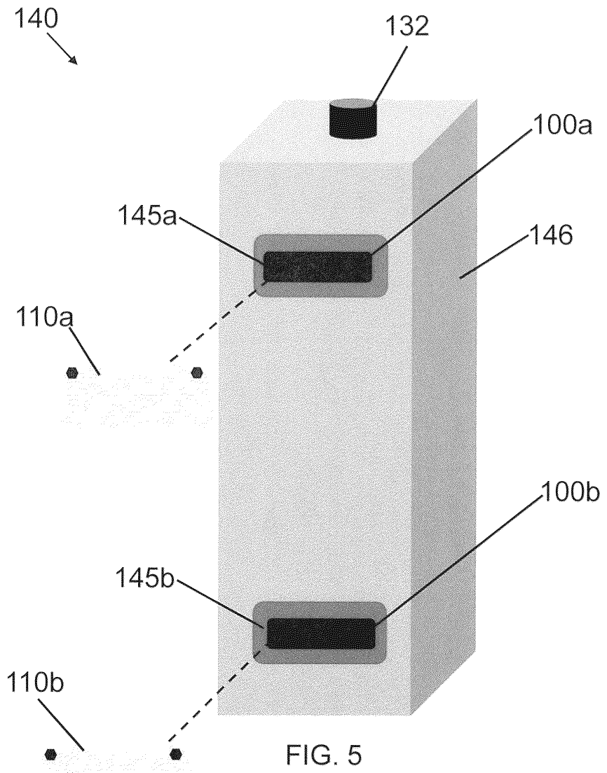

In accordance with certain aspects, a processing laser head and a laser system for performing material modification processes on a workpiece are disclosed. FIG. 4 is a cross-sectional view of a one example of a laser head 140, FIG. 5 is a perspective view of the laser head 140, and FIG. 6 is a simplified block diagram of one non-limiting example of a laser system 130 that includes the laser head 140. The laser system 130 includes a laser source 160 configured to generate a processing laser beam 142. The laser head 140 is configured to receive the processing laser beam 142 from the laser source 160.

The laser source 160 may be any one of a number of different types of laser sources, including solid-state, gas, fiber, and excimer lasers radiation sources. According to one embodiment, the laser source 160 is configured as a fiber laser and the processing laser beam 142 is supplied to the laser head by an optical fiber 125, as shown in FIG. 6. Suitable fiber laser sources for performing embodiments in this disclosure are available from IPG Photonics, Oxford, MA, USA. The laser beam 142 interacts with material of the workpiece 170 for performing the material modification process. Non-limiting examples of material modification processes include welding, cutting, drilling, brazing, annealing, soldering, and additive manufacturing.

The transparent window 104 functions to protect one or more optical assemblies in the laser head 140. The transparent window 104 comprises at least one planar surface and is optically transparent to the processing laser beam 142. The transparent window 104 can be constructed from any one or a number of different materials, non-limiting examples of which include fused silica, zinc selenide, zine sulfide, sapphire (Al₂O₃), calcium fluoride, magnesium fluoride, barium fluoride, sodium chloride, potassium bromide, glass materials, etc. In addition, one or more planar surfaces may be coated with an anti-reflection coating. The transparent window 104 is thus configured to maximize transmission in a specified wavelength range, while minimizing reflection and absorption. According to at least one embodiment, the optic assembly protected by the transparent window is configured to focus the processing laser beam 142 and according to another embodiment, the optic assembly is configured to collimate the processing laser beam 142.

In one embodiment, the laser head 140 includes focusing optics 144 configured to focus the processing laser beam 142. Depending on the desired application, the processing laser beam 142 may be focused above, onto, or beneath the workpiece 170. The focusing optics 144 may include one or more lenses and/or other optical components as will be appreciated by those in the art. For example, the focusing optics 144 may comprise one or more cylindrical lenses, one or more spherical lenses, and in some instances may also include one or more spherical and/or cylindrical mirrors. A multiwindow cartridge assembly 100b is disposed downstream of the focusing optics 144, as shown in FIGS. 4 and 6. The transparent window 104b of multiwindow cartridge assembly 100b functions to protect the focusing optics 144 from splatter and debris during laser processing operations. The focusing optics 144 are typically expensive components and require being free from contamination to perform optimally.

According to another embodiment, the laser head 140 includes a collimator 134 configured to collimate the processing laser beam 142. The collimator 134 is positioned upstream from the focusing optics 144. The collimator 134 includes one or more collimator lenses that collimate the light out of the delivery fiber 125. The delivery fiber 125 attaches to the laser head 140 using fiber receiver 132. A multiwindow cartridge assembly 100a is disposed upstream from the collimator 134. The transparent window 104a of the multiwindow cartridge assembly 100a functions to protect the collimator 134 from various sources of contamination. For instance, when the optical fiber 125 is first positioned in the receiver 132, debris from the optical fiber 125 and/or the receiver 132 can be introduced to surfaces of the collimator 134, which increases absorption on the lens and is detrimental to the functionality and operating life of the lens or lenses. Furthermore, contamination adheres to other surfaces in the laser head, and these become dislodged and attach to optics within the head, including the collimator 134. The transparent window 104a of multiwindow cartridge assembly 100a thus protects the collimator 134 from these sources of contamination.

Turning now to FIG. 5, according to certain embodiments the laser head 140 also includes a housing 146 that is configured with an opening 145 that exposes at least a portion of the multiwindow cartridge assembly 100. For instance, the opening 145 exposes at least a portion of the rotation mechanism 108 and the position indicator 120. The example shown in FIG. 5 has two such openings, 145a for multiwindow cartridge assembly 100a (associated with protecting the collimator 134) and 145b for multiwindow cartridge assembly 110b (associated with protecting the focusing optics 144). In a further aspect, the laser system also includes a cover door 110 that is configured to attach to the housing 146 and cover the opening 145. As shown in FIG. 5, in this example, cover door 110a covers opening 145a and cover door 110b covers opening 145b. Housing 146 also includes an aperture 148 (see FIG. 4) or opening that allows passage of the processing laser beam 142 and aligns with optical axis 103, aperture 105a of multiwindow cartridge assembly 100a, and aperture 105b of multiwindow cartridge assembly 100b. Focusing optics 144 and the collimator 134 extend into this aperture 148 of the housing 146.

In accordance with other embodiments, the laser head includes a housing that is configured to seal the multiwindow cartridge(s) 100 within an interior of the housing (not shown in figures). In such a configuration the housing provides a gas-impermeable (or substantially gas-impermeable) enclosure having a hermetic closure. In this configuration, an actuator could be controlled by controller 150 to actuate rotation of the window mount and thus act as the rotation mechanism. The controller 150 may also be configured to keep track of how many “clean” rotational positions are remaining and send an alert to a user (e.g., via a display device) when all rotational positions on the window have been contaminated. This configuration may be used in applications where even less interaction (e.g., opening up) with the laser head is desired.

In accordance with another aspect, the laser system 130 also includes a contamination sensor 136 that is configured to detect contamination on at least one planar surface of the transparent window 104. For instance, contamination on the at least one planar surface creates scattered light (radiation) and the sensor 136 is configured to detect the scattered light (i.e., an intensity of the scattered radiation). According to some embodiments, contamination sensor 136 is configured to conduct a contamination measurement of the planar surface of the window 104. FIG. 6 includes contamination sensor 136a associated with monitoring transparent window 104a that protects collimator 134 and contamination sensor 136b is associated with monitoring transparent window 104b that protects focusing optics 144. In one embodiment, contamination sensor 136a is positioned or otherwise disposed to monitor an upper (upstream) surface of the transparent window 104a, which is closest to the source or sources of contamination (e.g., the optical fiber 125 and receiver 132). In another embodiment, contamination sensor 136b is positioned or otherwise disposed to monitor a lower (downstream) surface of the transparent window 104b, which is closest to the source or sources of contamination (e.g., workpiece and material modification process).

Laser system 130 also includes a controller 150 that is coupled to the contamination sensor 136 (e.g., contamination sensors 136a and 136b) and provides feedback to a user regarding the contamination status, e.g., when the contamination exceeds a threshold level. For example, the controller 150 in one embodiment is configured to receive a contamination measurement (i.e., measured intensity) from the contamination sensor 136, compare the contamination measurement to a predetermined contamination threshold value, and responsive to the comparison, send a notification to a display device 155. According to one embodiment, the contamination sensor 136 is configured as a visible light photodiode. In some embodiments, the notification can convey that the contamination measurement has not exceeded a predetermined contamination threshold value. According to a further aspect, the controller is configured to send the notification when the contamination measurement exceeds the predetermined contamination threshold value. The predetermined contamination threshold value can be set by a user (and programmed into the controller 150), who will also be notified via the display device 155 (e.g., an electronic device with a screen) that the transparent window 104 is now “dirty.” When this happens, the user may remove cover door 110 to access the rotation mechanism 108 of the multiwindow cartridge assembly 100, turn the rotation mechanism 108 to the next “clean position” (rotational position) using the position indicator 120, and then place the cover door 110 back onto the housing 146 to cover the opening 145. In certain embodiments with a fully sealed laser head, controller 150 controls an actuator that rotates the window 104 (e.g., automatically in response to measurements from sensor 136 and/or 138, or in response to input by a user). Even without a fully sealed laser head, according to some embodiments, the controller 150 may control an actuator that rotates the window 104. When all of the processing rotational positions have been used, the multiwindow cartridge assembly 100 can be removed and replaced with a new multiwindow cartridge assembly. By some estimates, the implementation of the multiwindow cartridge assembly can reduce downtime by as much as 90% and the multiwindow cartridge assembly can be used continuously (without being replaced) for as long as a year.

According to another aspect, the laser system also includes a temperature sensor 138. The temperature sensor 138 is configured to monitor (i.e., measure) a temperature in the vicinity of the transparent window 104. Many laser processes implement the use of high power lasers (e.g., at least 1 kW of power) that have the potential to generate heat within the laser head. Furthermore, when optics are contaminated with particles or other debris (e.g., a film), this contamination absorbs the laser radiation and generates heat. The more heat that is generated, the more contaminated the transparent window 104. Contamination on the transparent window 104 can be monitored by the temperature sensor 138 either alone or in addition to the contamination sensor 136. In the non-limiting example shown in FIG. 6, temperature sensor 138a is positioned or otherwise disposed in the vicinity of transparent window 104a and temperature sensor 138b is positioned in the vicinity of transparent window 104b.

According to one embodiment, the controller 150 is coupled to the temperature sensor 138 and configured to receive a temperature measurement from the temperature sensor 138. The controller 150 in some embodiments is configured to compare the temperature measurement to a predetermined temperature threshold value, which can be set by a user, and responsive to the comparison perform at least one of sending a notification to the display device 155 and controlling the laser source 160. For instance, the notification may relay to a user via the display device 155 that the temperature is “OK” or is increasing or decreasing since the last measurement. In some embodiments, the controller 150 is configured to send the notification to the display device 155 and/or control the laser source 160 when the temperature measurement exceeds the predetermined temperature threshold value. For instance, when the temperature exceeds the threshold value, a control signal may be sent to the laser source 160 to lower the power or power off the laser source 160. This may prevent further heat accumulation that could destroy optics within the laser head 140. In some embodiments, when the temperature measurement exceeds the threshold value, the user will be notified (via the display device 155), and the user may commence with rotating the transparent window 104 to a new rotational position or replacing the cartridge assembly as described above.

The contamination sensor 136 and/or temperature sensor 138 may be configured to measure at periodic time intervals during a laser processing operation, or in some instances continuously, and send the measurements to controller 150, which then performs the evaluation on the measurements.

It is to be appreciated that the controller 150 may be a processing computer or computing device that includes a processing unit operatively coupled to a memory that stores control logic and other data as understood by those skilled in the art. For instance, controller 150 is configured to communicate with one or more components of laser system 130, including laser source 160, contamination sensors 136a and 136b, and temperature sensors 138a and 138b. Controller 150 may also be configured to communicate with components of the multiwindow cartridge assembly 100, such as the rotation mechanism 108 or other actuation mechanism as described above.

To implement a method in accordance with aspects of the disclosure a multiwindow cartridge assembly is used, as discussed above. According to some embodiments, a method of protecting an optics assembly included in a laser processing head comprises providing a multiwindow cartridge assembly that houses a transparent window, where the transparent window is configured to protect the optics assembly. Such a multiwindow cartridge assembly 100 is shown in the figures and discussed herein. The method also comprises exposing a first rotational processing position (124) on the transparent window to an environment containing contaminants. In reference to FIG. 2, the processing position 124a is such a first rotational processing position that is exposed to the contaminating environment. The method also comprises measuring an intensity of scattered radiation from a planar surface of the transparent window. This can be accomplished using contamination sensor 136 as described above. The method also includes comparing the measured intensity to a predetermined contamination threshold, as described above, and responsive to the comparison, providing a notification when the measured intensity exceeds the predetermined contamination threshold, as also described above. For instance, a notification can be sent to a display device for a user to see when the measured intensity exceeds the predetermined contamination threshold. The method may also include rotating the transparent window to a second rotational processing position when the measured intensity exceeds the predetermined contamination threshold. For example, the rotation mechanism 108 can be engaged with by a user or an actuator that rotates the transparent window to a second rotational processing position (e.g., 124b rotates into the former 124a position in FIG. 2). In some embodiments, the method also comprises providing a transparent window with N rotational processing positions and further comprises exposing, measuring, comparing, and rotating until each of the N rotational processing positions have been exposed. For example, in FIG. 2, N=8 and is associated with rotational processing positions 124a-124h. In some embodiments, the optics assembly is configured to focus a processing laser beam that is passed through the laser head and the first rotational processing position. Focusing optics 144 are one such type of optics assembly. In some embodiments, the optics assembly is configured to collimate a processing laser beam that is passed through the laser head and the first rotational processing position. Collimator 134 is one such type of optics assembly. In another embodiment, the method further comprises measuring a temperature in a vicinity of the transparent window. This can be accomplished using temperature sensor 138 as described above. In addition, the method can include comparing the measured temperature to a predetermined temperature threshold and responsive to the comparison, performing at least one of providing a notification and controlling a laser source that generates a processing laser beam that is passed through the laser head when the measured temperature exceeds the predetermined temperature threshold. For instance, a notification can be sent to a display device for a user to see, or the laser source can have an operating parameter adjusted (e.g., lower output power, turn off laser power) when the measured temperature exceeds the predetermined temperature threshold. The method also comprises rotating the transparent window to a second rotational processing position when the measured temperature exceeds the predetermined temperature threshold, as described herein. In some embodiments, the method also comprises providing the laser processing head. One non-limiting example of such a laser head is described herein and shown in FIGS. 4-6.

According to another embodiment, the window mount 104 is configured to support more than one transparent window. For instance, instead of a single piece of transparent material that rotates, the window mount may be configured to hold multiple windows that can be rotated into the aperture 105 and exposed to the processing laser beam 142. In one embodiment, multiple circular windows are arranged in a circumference on the window mount. Each window may be sized to accommodate the dimensions of the aperture 105 such that transparent material extends across the aperture 105 when the window is rotated into place.

In accordance with another aspect, the transparent window 104 is coupled to at least a portion of an optics assembly that optically interacts with the processing laser beam 142. For instance, a focus body assembly or a collimator body assembly could be added to the respective assembly as an accessory and installed in the laser head. The assembly could be installed with an opening so as to access the rotational mechanism 108 or the assembly can be sealed within the housing of the laser head, as described above.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls. Moreover, titles or subtitles may be used in the specification for the convenience of a reader, which shall have no influence on the scope of the present invention.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

1. A multiwindow cartridge assembly, comprising:
a window mount configured to support and rotate a transparent window about a rotation axis;
an aperture configured for permitting passage of a processing laser beam along an optical axis, the optical axis passing through a processing position on the transparent window;
a housing for enclosing at least a portion of the transparent window and the window mount and configured to form at least a portion of the aperture; and
a rotation mechanism configured to engage with at least a portion of the window mount for rotating the transparent window about the rotation axis to rotational positions, the rotational positions including the processing position.

2. The multiwindow cartridge assembly of claim 1, wherein the window mount is further configured to support the transp window at an angle.

3. The multiwindow cartridge assembly of claim 1, further comprising a position indicator configured to indicate the rotational position of the transparent window.

4. The multiwindow cartridge assembly of claim 1, wherein the optical axis is parallel to the rotation axis.

5. The multiwindow cartridge assembly of claim 1, further comprising a frame assembly configured to hold the transparent window in the housing.

6. The multiwindow cartridge assembly of claim 1, wherein the window mount is a first window mount and the assembly further comprises a second window mount configured to support and rotate a second transparent window.

7. The multiwindow cartridge assembly of claim 1, wherein the transparent window is coupled to at least a portion of an optic assembly that optically interacts with the processing laser beam and is configured to focus and/or collimate the processing laser beam.

8-9. (canceled)

10. The multiwindow cartridge assembly of claim 1, wherein the window mount is configured to support more than one transparent window.

11. A laser system for performing a material modification process on a workpiece comprising:
a laser source configured to generate a processing laser beam; and
a laser head, the laser head configured to receive the processing laser beam from the laser source and including:
focusing optics configured to focus the proces laser beam;
a multiwindow cartridge assembly disposed downstream of the focusing optics, the multiwindow cartridge assembly including:
a window mount configured to support and rotate a transparent window. about a rotation axis;
an aperture configured for permitting passage of the processing laser beam along an optical axis, the optical axis passing through a processing position on the transparent window;
a housing for enclosing at least a portion of the transparent window and the window mount and configured to form at least a portion of the aperture; and
a rotation mechanism configured to engage with at least a portion of the window mount for rotating the transparent window about the rotation axis to rotational positions, the rotational positions including the processing position.

12. The laser system of claim 11, wherein the laser head further includes a contamination sensor configured to detect contamination on at least one planar surface of the transparent window.

13. (canceled)

14. The laser system of claim 12, further comprising a controller coupled to the contamination sensor and configured to:
receive a contamination measurement from the contamination sensor;
compare the contamination measurement to a predetermined contamination threshold value; and
responsive to the comparison, send a notification to a display device.

15. The laser system of claim 14, wherein the controller is configured to send the notification when the contamination measurement exceeds the predetermined contamination threshold value.

16. The laser system of claim 11, wherein the laser head further includes a temperature sensor and the controller is configured to:
receive a temperature measurement from the temperature sensor;
compare the temperature measurement to a predetermined temperature threshold value; and
responsive to the comparison, perform at least one of:
send a notification to the display device; and
control the laser source.

17. The laser system of claim 16, wherein the controller is configured to send the notification and/or control the laser source when the temperature measurement exceeds the predetermined temperature threshold value.

18. The laser system of claim 11, wherein the multiwindow cartridge assembly is a first multiwindow cartridge assembly and the laser head further comprises:
a collimator configured to collimate the processing laser beam, the collimator positioned upstream from the focusing optics, and
a second multiwindow cartridge assembly disposed upstream of the collimator.

19. The laser system of claim 11, wherein the window mount of the multiwindow cartridge assembly is configured to support the transparent window at an angle.

20. The laser system of claim 11, wherein the multiwindow cartridge assembly further includes a position indicator configured to indicate the rotational position of the transparent window.

21. The laser system of claim 20, wherein the laser head further includes a housing configured with an opening that exposes at least a portion of the rotation mechanism and the position indicator.

22. The laser system of claim 21, wherein the laser head further includes a cover door configured to attach to the housing and cover the opening.

23. The laser system of claim 11, wherein the laser head further includes a housing configured to seal the multiwindow cartridge within an interior of the housing.

24-32. (canceled)

33. A laser processing head, comprising:
focusing optics configured to focus a processing laser beam;
a multiwindow cartridge assembly disposed downstream of the focusing optics, the multiwindow cartridge assembly including:
a window mount configured to support and rotate a transparent window about a rotation axis;
an aperture configured for permitting passage of the processing laser beam along an optical axis, the optical axis passin g through a processing position on the transparent window;
a housing for enclosing at least a portion of the transparent window and the window mount and configured to form at least a portion of the aperture; and
a rotation mechanism configured to engage with at least a portion of the window mount for rotating the transparent window about the rotation axis to rotational positions, the rotational positions including the processing position.

34. The laser processing head of claim 33, wherein the multiwindow cartridge assembly is a first multiwindow cartridge assembly and the laser processing head further comprises:
a collimator configured to collimate the processing laser beam, the collimator positioned upstream from the focusing optics, and
a second multiwindow cartridge assembly disposed upstream of the collimator.

35. The laser processing head of claim 33, further comprising at least one of a contamination sensor configured to detect contamination on at least one planar surface of the transparent window and a temperature sensor configured to measure a temperature in a vicinity of the transparent window.

36. The laser processing head of claim 33, wherein the window mount of the multiwindow cartridge assembly is configured to support the transparent window at an angle.

37. The laser processing head of claim 33, wherein the multiwindow cartridge assembly further includes a position indicator configured to indicate the rotational position of the transparent window.

38. The laser processing head of claim 33, further comprising a housing configured with an opening that exposes at least a portion of the rotation mechanism and the position indicator.

39. The laser processing head of claim 33, further comprising a cover door configured to attach to the housing and cover the opening.

40. The laser processing head of claim 33, further comprising a housing configured to seal the multiwindow cartridge within an interior of the housing.

41. (canceled)
